(19) United States
(12) Patent Application Publication
(10) Pub. No.: US 2023/0294191 A1
(43) Pub. Date: Sep. 21, 2023

(54) MOLDED OBJECT MANUFACTURING METHOD AND MOLDED OBJECT

(71) Applicant: KABUSHIKI KAISHA KOBE SEIKO SHO (KOBE STEEL, LTD.), Hyogo (JP)

(72) Inventor: Takahiro SHINOZAKI, Hyogo (JP)

(73) Assignee: KABUSHIKI KAISHA KOBE SEIKO SHO (KOBE STEEL, LTD.), Hyogo (JP)

(21) Appl. No.: 18/041,480

(22) PCT Filed: Jul. 26, 2021
(86) PCT No.: PCT/JP2021/027604

§ 371 Date: Feb. 13, 2023

(30) Foreign Application Priority Data
Aug. 19, 2020 (JP) 2020-138614

(51) Int. Cl. B23K 9/04

(52) U.S. Cl. CPC B23K 9/048; B33Y 10/00

(57) ABSTRACT

A method for manufacturing an additively-manufactured object incudes a groove portion processing step, a groove portion closing step, and a building step. In the groove portion processing step, a groove portion is formed by cutting an outer periphery of the shaft body. In the groove portion closing step, a first weld bead is formed along the groove portion on an edge portion of the groove portion in a shaft body to close the groove portion to form a hollow portion. In the building step, a built-up portion is built by depositing a second weld on the outer periphery of the shaft body.

### TECHNICAL FIELD

The present invention relates to a method for manufacturing an additively-manufactured object and an additively-manufactured object.

### BACKGROUND ART

In recent years, needs for 3D printers as a means of production have been increasing, and especially for application to metal materials, research and development have been carried out for practical use in the aircraft industry and the like. A 3D printer using a metal material is configured to melt a metal powder or a metal wire by using a heat source such as a laser or an arc, and deposit the molten metal to manufacture an additively-manufactured object.

For example, as a technique for manufacturing a rotor having a blade, there is a technique in which weld beads are deposited around a shaft body as a central shaft to build a built-up portion, and an outer periphery of the built-up portion is then cut to form a blade (see, for example, Patent Literature 1).

There is also a common technique in which an additively-manufactured object having an internal space is manufactured by forming a closing wall portion with weld beads on an opening portion of a deposited body built by depositing the weld bead to close the opening portion (see, for example, Patent Literature 2).

### CITATION LIST

### Patent Literature

Patent Literature 1: JP 2019-155463 A

Patent Literature 2: JP 2020-66027 A

### SUMMARY OF INVENTION

### Technical Problem

When the rotor is manufactured as described in Patent Literature 1, it may be required to form a flow path through which a cooling medium flows inside the rotor. In this case, when the weld bead is deposited around the shaft body to build the built-up portion, it is conceivable to form an internal space with the weld bead as in the technique described in Patent Literature 2.

However, in this case, a time for building the built-up portion accompanying the building of the internal space with the weld bead increases, and a lead time required for manufacturing becomes long. When the weld bead is deposited to form a side wall portion of the internal space, an inner surface of the internal space may be uneven, which may impede smooth flow of the cooling medium.

The present invention has been made in view of the above circumstances, and an object of the present invention is to provide a method for manufacturing an additively-manufactured object capable of building an additively-manufactured object having a hollow portion as a flow path easily and with high accuracy, and an additively-manufactured object.

### Solution to Problem

The present invention has the following configuration.

(1) A method for manufacturing an additively-manufactured object, the additively-manufactured object comprising a rod-shaped shaft body, and a built-up portion formed by depositing weld beads obtained by melting and solidifying a filler metal on an outer periphery of the shaft body, the method comprising:
a groove portion processing step of forming a groove portion by cutting the outer periphery of the shaft body;
a groove portion closing step of forming the weld bead along the groove portion on an edge portion of the groove portion in the shaft body to close the groove portion to form a hollow portion; and
a building step of building the built-up portion by depositing the weld bead on the outer periphery of the shaft body.

(2) An additively-manufactured object comprising:
a rod-shaped shaft body;
a built-up portion provided on an outer periphery of the shaft body and formed by depositing weld beads obtained by melting and solidifying a filler metal; and
a hollow portion formed along the outer periphery of the shaft body,
wherein the hollow portion is surrounded by a groove portion formed in the outer periphery of the shaft body, and the weld bead formed along an edge portion of the groove portion to close the groove portion.

### Advantageous Effects of Invention

In the present invention, an additively-manufactured object having a hollow portion as a flow path can be manufactured easily and with high accuracy.

### BRIEF DESCRIPTION OF DRAWINGS

FIG. 1A and FIG. 1B illustrate an additively-manufactured object manufactured by a manufacturing method in the present invention, and FIG. 1A is a schematic side view of the additively-manufactured object, and FIG. 1B is a schematic cross-sectional view of the additively-manufactured object.

FIG. 2 is a schematic configuration diagram of a manufacturing system for manufacturing the additively-manufactured object.

FIG. 3A is a schematic side view of the additively-manufactured object along an axial direction in the middle of manufacturing and shows a manufacturing process of the additively-manufactured object.

FIG. 3B is a schematic side view of the additively-manufactured object along the axial direction in the middle of manufacturing and shows a manufacturing process of the additively-manufactured object.

FIG. 3C is a schematic side view of the additively-manufactured object along the axial direction in the middle of manufacturing and shows a manufacturing process of the additively-manufactured object.

FIG. 3D is a schematic side view of the additively-manufactured object along the axial direction in the middle of manufacturing and shows a manufacturing process of the additively-manufactured object.

FIG. 3E is a schematic side view of the additively-manufactured object along the axial direction in the middle of manufacturing and shows a manufacturing process of the additively-manufactured object.

FIG. 4 is a schematic side view of the additively-manufactured object including a hollow portion in the middle of manufacturing shown in FIG. 3B.

FIG. 5 is a schematic side view of the additively-manufactured object including the hollow portion in the middle of manufacturing shown in FIG. 3C.

FIG. 6 is a schematic side view of the additively-manufactured object including the hollow portion in the middle of manufacturing shown in FIG. 3D.

FIG. 7A is a schematic side view of the additively-manufactured object along the axial direction in the middle of manufacturing and shows a manufacturing process of the additively-manufactured object in a manufacturing method in another embodiment.

FIG. 7B is a schematic side view of the additively-manufactured object along the axial direction in the middle of manufacturing and shows a manufacturing process of the additively-manufactured object in the manufacturing method in the another embodiment.

FIG. 7C is a schematic side view of the additively-manufactured object along the axial direction in the middle of manufacturing and shows a manufacturing process of the additively-manufactured object in the manufacturing method in the another embodiment.

FIG. 7D is a schematic side view of the additively-manufactured object along the axial direction in the middle of manufacturing and shows a manufacturing process of the additively-manufactured object in the manufacturing method in the another embodiment.

### DESCRIPTION OF EMBODIMENTS

Hereinafter, embodiments of the present invention are described in detail with reference to the drawings.

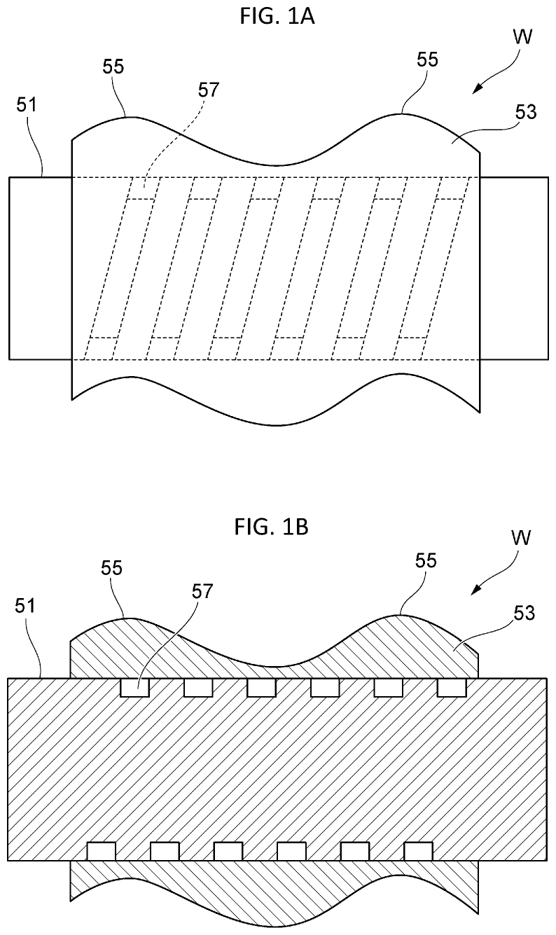

FIG. 1A and FIG. 1B illustrate an additively-manufactured object manufactured by the manufacturing method in the present invention, and FIG. 1A is a schematic side view of the additively-manufactured object, and FIG. 1B is a schematic cross-sectional view of the additively-manufactured object.

As shown in FIG. 1A and FIG. 1B, an additively-manufactured object W includes a shaft body 51, and a built-up portion 53 built on an outer periphery of the shaft body 51, and the built-up portion 53 has a blade 55 formed.

The additively-manufactured object W has a hollow portion 57.

The shaft body 51 is, for example, a round bar body having a circular cross-section such as a steel bar. The blade 55 provided on the outer periphery of the shaft body 51 is formed in a shape in which a portion protruding toward an outer peripheral side is spirally twisted in an axial direction. The blade 55 is formed by cutting the built-up portion 53 in which weld beads are formed and deposited around the shaft body 51. The hollow portion 57 is formed in the shaft body 51, and is spirally formed in the axial direction.

The additively-manufactured object W is used, for example, as a rotor of a mixer, a pump, or the like. In the additively-manufactured object W, for example, the spiral hollow portion 57 is used as a flow path through which a cooling medium such as cooling water flows. The cooling medium flows through the hollow portion 57, and thus the additively-manufactured object W is cooled.

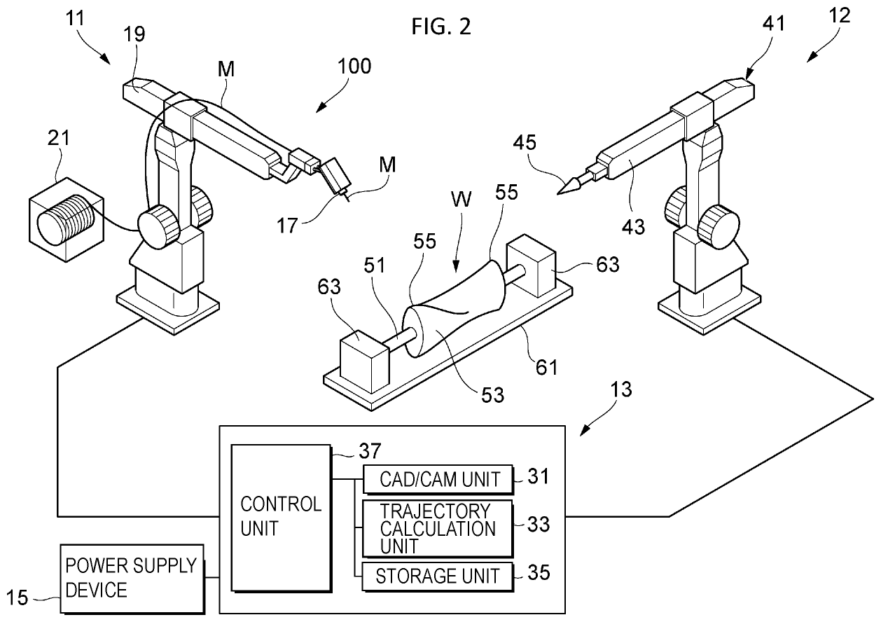

Next, a manufacturing system for manufacturing the additively-manufactured object W is described. FIG. 2 is a schematic configuration diagram of the manufacturing system for manufacturing the additively-manufactured object.

As shown in FIG. 2, a manufacturing system 100 in this configuration includes an additive manufacturing device 11, a cutting device 12, a controller 13 that integrally controls the additive manufacturing device 11 and the cutting device 12, and a power supply device 15.

The additive manufacturing device 11 includes a welding robot 19 including a torch 17 on a tip shaft thereof, and a filler metal supply unit 21 that supplies a filler metal (a welding wire) M to the torch 17. The torch 17 holds the filler metal M in a state of protruding from a tip thereof.

The welding robot 19 is a multi joint robot, and the torch 17 provided on the tip shaft is supported such that the filler metal M can be continuously supplied. A position and posture of the torch 17 can be set three-dimensionally desirably within a movable range of a robot arm.

The torch 17 includes a shield nozzle (not shown), and a shielding gas is supplied from the shield nozzle. An arc welding method used in this configuration may be either a consumable electrode-based method such as shielded metal arc welding method or carbon dioxide gas arc welding method, or a non-consumable electrode-based method such as TIG welding method or plasma arc welding method, and is appropriately selected depending on an additively-manufactured object W to be manufactured.

For example, in the case of the consumable electrode-based method, a contact tip is disposed inside the shield nozzle, and the contact tip holds the filler metal M to which a melting current is supplied. The torch 17 generates an arc from a tip of the filler metal M in a shielding gas atmosphere while holding the filler metal M. The filler metal M is fed from the filler metal supply unit 21 to the torch 17 by a delivery mechanism (not shown) attached to the robot arm or the like. Then, when the filler metal M fed continuously is melted and solidified while the torch 17 is moved, a linear weld bead, which is a melt-solidified body of the filler metal M, is formed.

A heat source for melting the filler metal M is not limited to the arc described above. A heat source using another system such as a heating system using an arc and a laser together, a heating system using a plasma, or a heating system using an electron beam or a laser may be used. In the case of heating with an electron beam or a laser, a heating amount can be controlled more precisely to keep the weld bead in a more proper state and to contribute to further improvement in quality of the additively-manufactured object W.

Any commercially available welding wire can be used as the filler metal M. For example, a wire specified by solid wires for MAG and MIG welding of mild steel, high tensile strength steel, and low temperature service steel (JIS Z 3312), flux-cored wires for arc welding of mild steel, high tensile strength steel, and low temperature service steel (JIS Z 3313), or the like can be used.

The cutting device 12 includes a cutting robot 41. The cutting robot 41 is a multi-joint robot, like the welding robot 19, and includes, for example, a metal processing tool 45 such as an end mill or a grinding stone at a tip portion of a tip arm 43. Accordingly, the cutting robot 41 can be three-dimensionally moved by the controller 13 such that a processing posture thereof can take any posture.

The cutting robot 41 cuts, with the metal processing tool 45, the shaft body 51, or the built-up portion 53 built on the shaft body 51.

The controller 13 includes a CAD/CAM unit 31, a trajectory calculation unit 33, a storage unit 35, and a control unit 37 to which these units are connected.

The CAD/CAM unit 31 creates shape data of the additively-manufactured object W to be manufactured, and then divides the additively-manufactured object W into a plurality of layers to generate layer shape data representing a shape of each layer. The trajectory calculation unit 33 calculates a movement trajectory of the torch 17 based on the generated layer shape data. The trajectory calculation unit 33 calculates a movement trajectory of the metal processing tool 45 based on the shape data. The storage unit 35 stores data such as the shape data of the additively-manufactured object W, the generated layer shape data, the movement trajectory of the torch 17, and the movement trajectory of the metal processing tool 45.

The control unit 37 drives the welding robot 19 by executing a drive program based on the layer shape data and the movement trajectory of the torch 17 which are stored in the storage unit 35. That is, the welding robot 19 moves the torch 17 while melting the filler metal M with an arc based on the movement trajectory of the torch 17 generated by the trajectory calculation unit 33 in response to a command from the controller 13. The control unit 37 drives the cutting robot 41 by executing a drive program based on the shape data and the movement trajectory of the metal processing tool 45 which are stored in the storage unit 35. Accordingly, the shaft body 51 or the built-up portion 53 are cut by the metal processing tool 45 provided on the tip arm 43 of the cutting robot 41.

The manufacturing system 100 having the above configuration drives the welding robot 19 to move the torch 17 along the movement trajectory of the torch 17 generated based on the set layer shape data, and deposits the weld bead made of the molten filler metal M around the shaft body 51 with the torch 17 while rotating the shaft body 51 about its axis. Accordingly, the additively-manufactured object W in which the built-up portion 53 formed by the weld bead is built on the outer periphery of the shaft body 51 is manufactured. The additively-manufactured object W is formed into a designed outer shape by cutting with the metal processing tool 45 of the cutting device 12. Both ends of the shaft body 51 are supported by respective support portions 63 provided on a base 61 so as to be rotatable.

Next, a method for manufacturing the additively-manufactured object in the present invention is described.

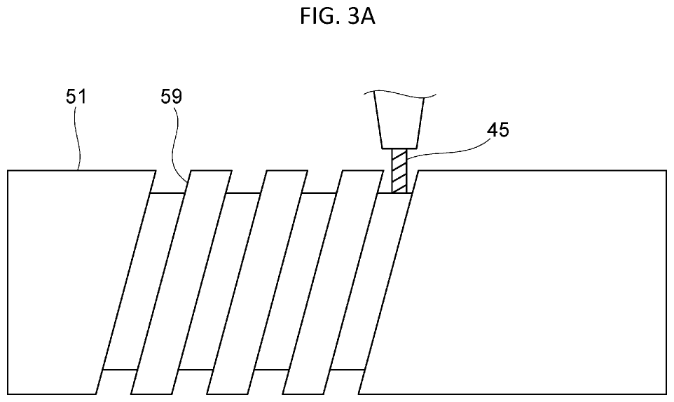

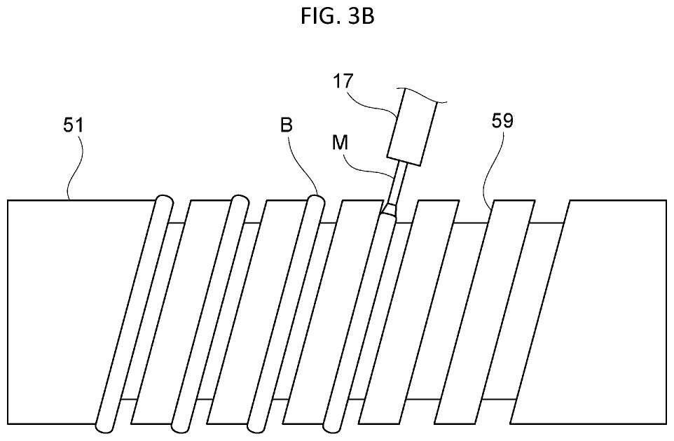

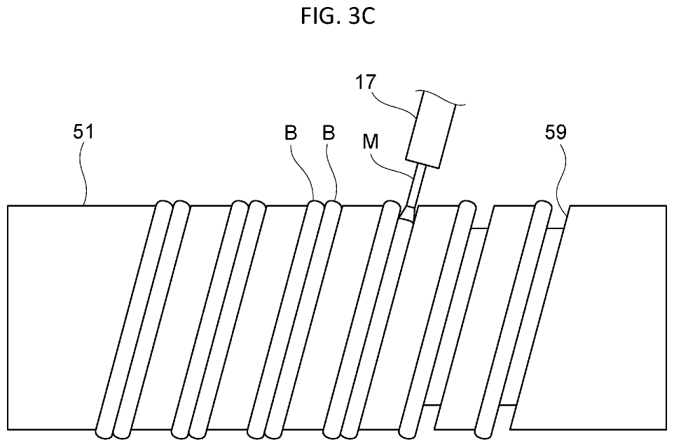

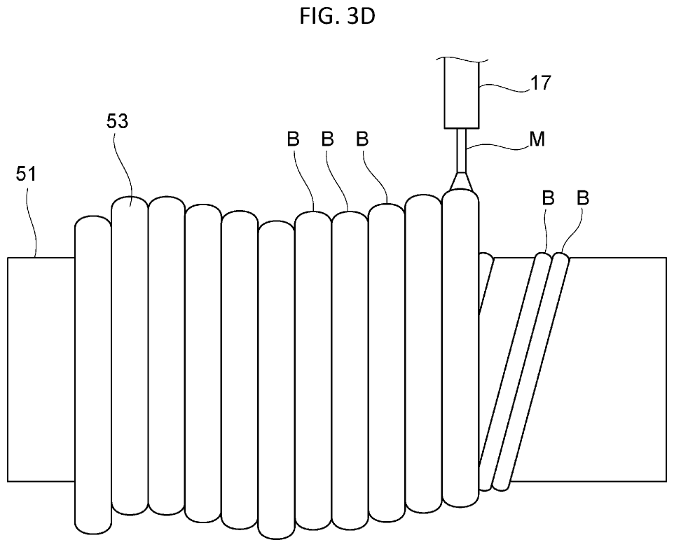

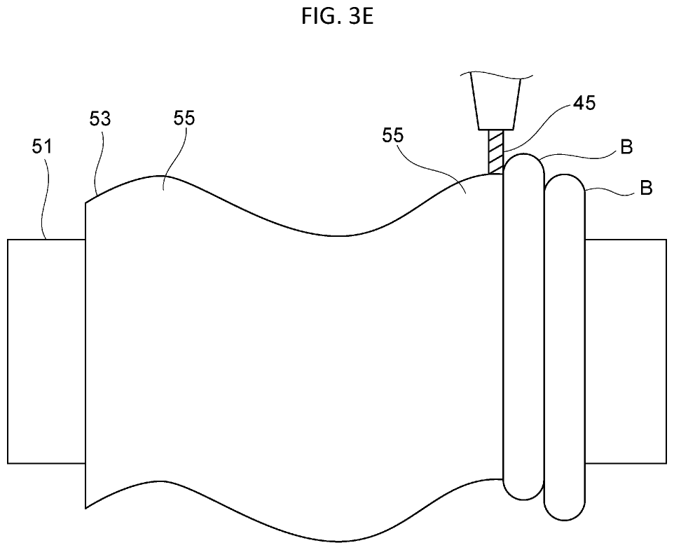

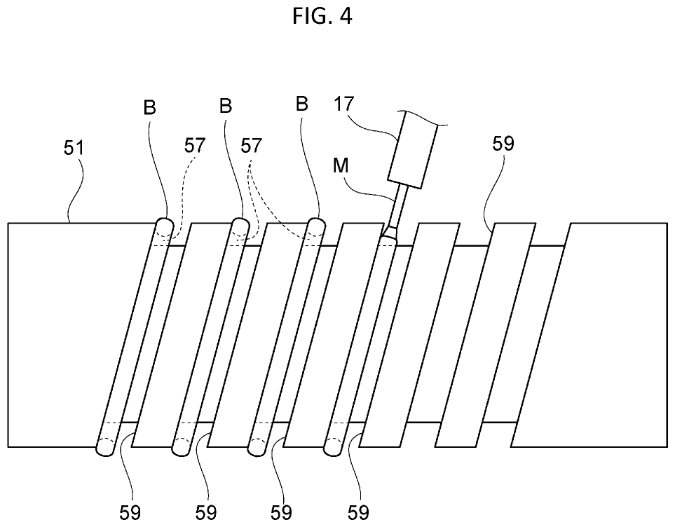

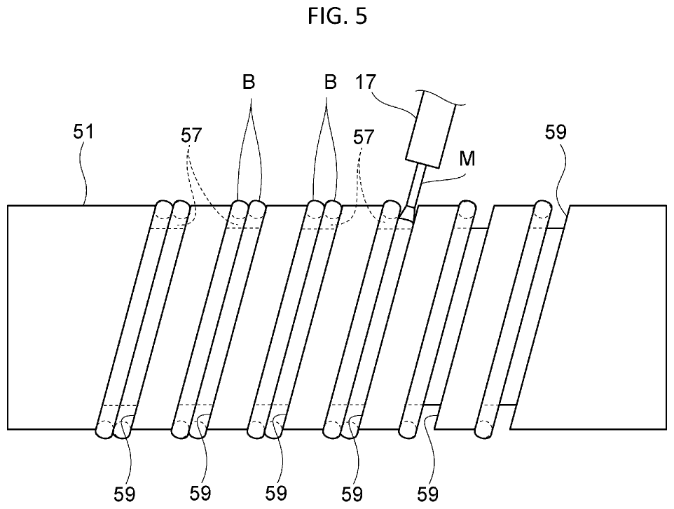

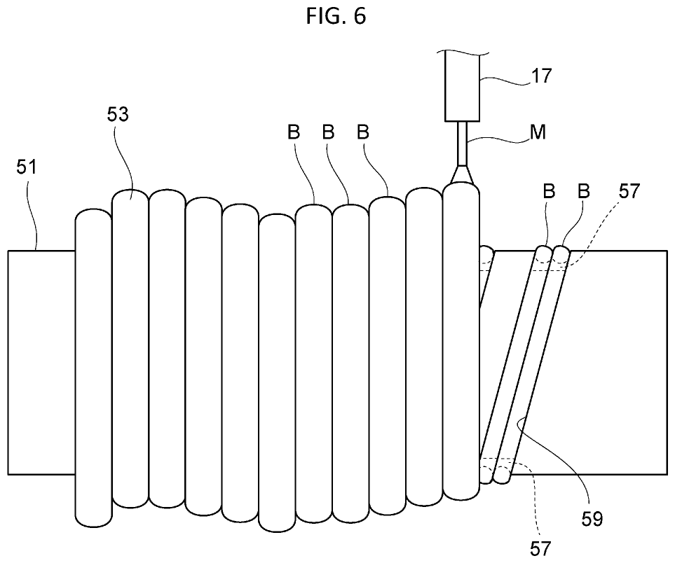

FIG. 3A to FIG. 3E are schematic side views of the additively-manufactured object along the axial direction in the middle of manufacturing and show manufacturing processes of the additively-manufactured object. FIG. 4 is a schematic side view of the additively-manufactured object including the hollow portion in the middle of manufacturing shown in FIG. 3B. FIG. 5 is a schematic side view of the additively-manufactured object including the hollow portion in the middle of manufacturing shown in FIG. 3C. FIG. 6 is a schematic side view of the additively-manufactured object including the hollow portion in the middle of manufacturing shown in FIG. 3D.

(Groove Portion Processing Step)

As shown in FIG. 3A, a groove portion 59 is formed by cutting the outer periphery of the shaft body 51. Specifically, an outer peripheral surface of the shaft body 51 is cut by the metal processing tool 45 of the cutting device 12 while rotating the shaft body 51 whose both ends are supported by the respective support portions 63. At this time, the metal processing tool 45 is moved from one end side to the other end side of the shaft body 51. Accordingly, the groove portion 59 is spirally formed along the axial direction in the outer periphery of the shaft body 51.

(Groove Portion Closing Step)

As shown in FIG. 3B and FIG. 4 and FIG. 3C and FIG. 5, weld beads B are formed along the groove portion 59 on respective edge portions of the groove portion 59 in the shaft body 51 to close the groove portion 59. Specifically, first, as shown in FIG. 3B and FIG. 4, while rotating the shaft body 51, the torch 17 is moved along one edge portion of the groove portion 59 to form the weld bead B on the one edge portion of the groove portion 59. Further, as shown in FIG. 3C and FIG. 5, while rotating the shaft body 51, the torch 17 is moved along the other edge portion of the groove portion 59 to form the weld bead B in a gap between the other edge portion of the groove portion 59 and the already formed weld bead B. Accordingly, the groove portion 59 is closed by the formed weld beads B. In this way, by closing the groove portion 59 with the weld beads B, the hollow portion 57 is spirally formed along the axial direction in the outer periphery of the shaft body 51 by the groove portion 59 and the weld beads B closing the groove portion 59.

When the weld beads B closing the groove portion 59 are formed, for example, it is preferable to form precise weld beads with a low heat input. Accordingly, it is possible to satisfactorily close the groove portion 59 while preventing dripping of the weld beads B into the groove portion 59. The number of weld beads B closing the groove portion 59 is increased or decreased depending on a width of the groove portion 59. For example, when the width of the groove portion 59 is large, the weld beads B are formed respectively on both edge portions of the groove portion 59, and further, a weld bead B is formed in a gap between these weld beads B.

(Building Step)

As shown in FIG. 3D and FIG. 6, while rotating the shaft body 51 in which the groove portion 59 is closed by the weld beads B, a weld bead B is formed and deposited along a peripheral direction around the shaft body 51 by the torch 17. Accordingly, the built-up portion 53 formed by the deposited weld bead B is built on the outer periphery of the shaft body 51. When the weld beads B building the built-up portion 53 are formed, for example, it is preferable to form the weld beads having a large cross-sectional area with a high heat input. Accordingly, the built-up portion 53 can be efficiently built by the weld beads B.

(Cutting Step)

As shown in FIG. 3E, while rotating the shaft body 51, an outer periphery of the built-up portion 53 built on the outer periphery of the shaft body 51 is cut by the metal processing tool 45 of the cutting device 12. Accordingly, the blade 55 is formed on the built-up portion 53.

As described above, in the method for manufacturing the additively-manufactured object W in the present embodiment, the outer periphery of the shaft body 51 is cut to form the groove portion 59, the weld beads B are formed along the respective edge portions of the groove portion 59 to close the groove portion 59 to form the hollow portion 57, and the weld beads B are deposited on the outer periphery of the shaft body 51 to build the built-up portion 53. Accordingly, the additively-manufactured object W having the hollow portion 57 formed by the groove portion 59 and the weld beads B closing the groove portion 59 can be manufactured. In the manufacturing method, it is possible to reduce the number of building steps using the weld bead B, and to greatly reduce the difficulty of forming the hollow portion 57 as compared with a case where a side wall portion and a ceiling portion are built using the weld beads B to form a hollow portion. Accordingly, the additively-manufactured object W having the hollow portion 57 can be manufactured easily and with high accuracy, and a lead time required for manufacturing can be greatly shortened. In the additively-manufactured object W manufactured by the manufacturing method, the formed hollow portion 57 can be used as, for example, a flow portion through which a cooling medium passes.

After the building step of building the built-up portion 53, the cutting step of cutting the built-up portion 53 to form the blade 55 is performed. Accordingly, the additively-manufactured object W with the blade and having the hollow portion 57 used as the flow path can be obtained.

In addition, by spirally forming the groove portion 59 with respect to the shaft body 51, it is possible to easily manufacture the additively-manufactured object W having the flow path formed by the hollow portion 57 covering the periphery of the shaft body 51 in the axial direction. As compared with the case where the side wall portion is built by the weld beads B, the hollow portion 57 as the flow path can be easily extended.

Next, a method for manufacturing the additively-manufactured object W in another embodiment is described.

The same components as those in the above embodiment are denoted by the same reference numerals, and description thereof is omitted.

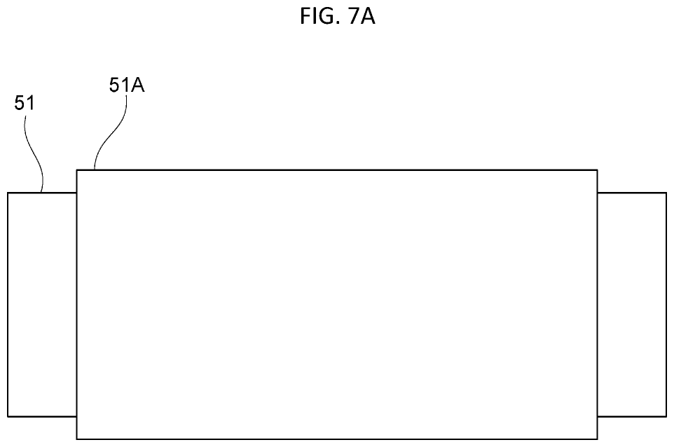

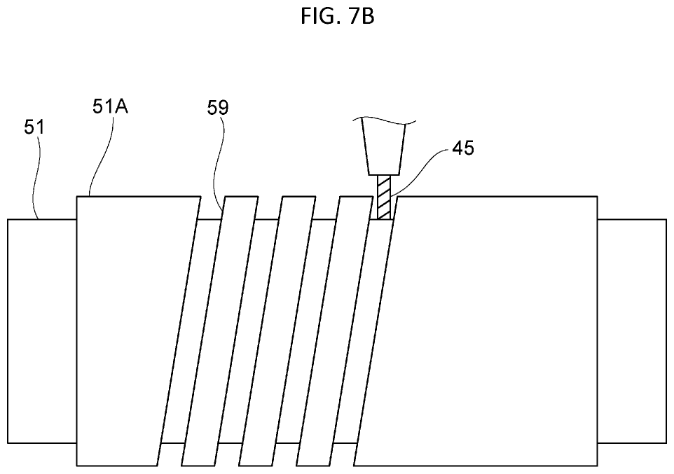

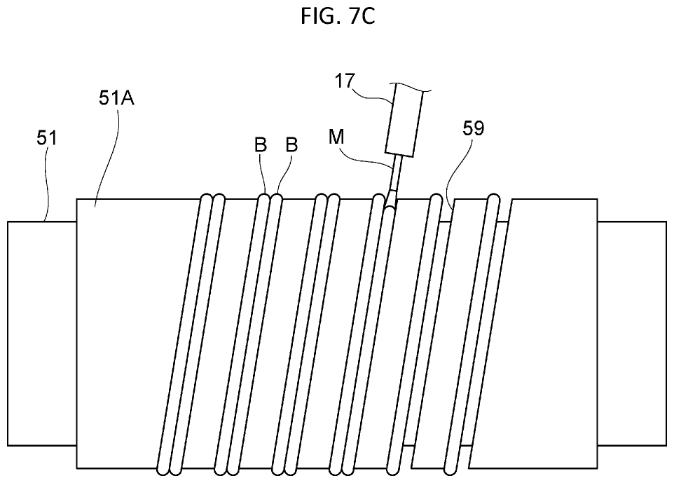

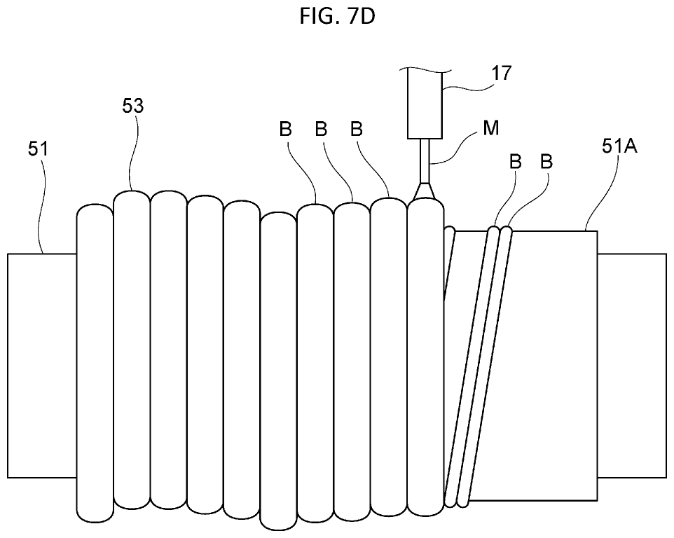

FIG. 7A to FIG. 7D are schematic side views of the additively-manufactured object along the axial direction in the middle of manufacturing and show manufacturing processes of the additively-manufactured object.

In the another embodiment, as shown in FIG. 7A, the stepped shaft body 51 having a large diameter portion 51A is used. The stepped shaft body 51 having the large diameter portion 51A is obtained by, for example, cutting a round bar body having an outer diameter of the large diameter portion 51A with a lathe or the like.

When the additively-manufactured object W is manufactured using the stepped shaft body 51, as shown in FIG. 7B, first, an outer peripheral surface of the large diameter portion 51A is cut by the metal processing tool 45 of the cutting device 12 while rotating the shaft body 51 whose both ends are supported by the respective support portions 63. At this time, the metal processing tool 45 is moved from one end side to the other end side of the shaft body 51. Accordingly, the groove portion 59 is spirally formed along the axial direction in an outer periphery of the large diameter portion 51A of the shaft body 51 (a groove portion processing step).

Next, as shown in FIG. 7C, while rotating the shaft body 51, the torch 17 is moved along an edge portion of the groove portion 59 formed in the large diameter portion 51A to form a weld bead B on one edge portion of the groove portion 59. Further, the torch 17 is moved along the other edge portion of the groove portion 59 to form a weld bead B in a gap between the other edge portion of the groove portion 59 and the already formed weld bead B. Accordingly, the groove portion 59 is closed by the formed weld beads B, and the hollow portion 57 is spirally formed along the axial direction (a groove portion closing step).

Further, as shown in FIG. 7D, while rotating the shaft body 51 in which the groove portion 59 is closed by the weld beads B, a weld bead B is formed and deposited along a peripheral direction around the large diameter portion 51A of the shaft body 51 by the torch 17. Accordingly, the built-up portion 53 formed by the large diameter portion 51A and the deposited weld bead B is built on the outer periphery of the shaft body 51 (a building step). At this time, since the shaft body 51 has the large diameter portion 51A, the number of weld beads B to be deposited can be greatly reduced.

Thereafter, while rotating the shaft body 51, the outer periphery of the built-up portion 53 formed by the large diameter portion 51A and the deposited weld bead B is cut by the metal processing tool 45 of the cutting device 12 (see FIG. 3E). Accordingly, the blade 55 is formed in the built-up portion 53 (a cutting step).

As described above, in the manufacturing method in the another embodiment, the shaft body 51 having the large diameter portion 51A is used, and thus it is possible to greatly reduce the number of deposited weld beads B when the built-up portion 53 is built by the weld beads B, and to improve the manufacturing efficiency. By using the shaft body 51 having the large diameter portion 51A, it is possible to easily manufacture a rotor having a large diameter or the like.

The groove portion 59 is formed in the large diameter portion 51A of the shaft body 51, and thus the groove portion 59 having a large depth can be easily formed. Accordingly, the additively-manufactured object W having the larger hollow portion 57 can be easily manufactured.

In the above embodiments, the groove portion 59 is formed in the shaft body 51 by the cutting device 12 including the cutting robot 41, and may be formed not only by the cutting robot 41 but also by, for example, a milling device equipped with an end mill or a groove milling cutter.

The groove portion 59 may be formed with a constant depth, and may be formed by adjusting a depth of the groove portion 59 so as to increase or decrease depending on a protruding dimension or position of the blade 55 to be built.

As described above, the present invention is not limited to the above embodiments, and combinations of the respective configurations of the embodiments, and changes and applications made by those skilled in the art based on the description of the specification and common technology are also intended by the present invention and are included within the scope to be protected.

As described above, the present description discloses the following matters.

(1) A method for manufacturing an additively-manufactured object, the additively-manufactured object comprising a rod-shaped shaft body, and a built-up portion formed by depositing a weld bead obtained by melting and solidifying a filler metal on an outer periphery of the shaft body, the method comprising:
a groove portion processing step of forming a groove portion by cutting the outer periphery of the shaft body;
a groove portion closing step of forming the weld bead along the groove portion on an edge portion of the groove portion in the shaft body to close the groove portion to form a hollow portion; and
a building step of building the built-up portion by depositing the weld bead on the outer periphery of the shaft body.

In the method for manufacturing the additively-manufactured object, the outer periphery of the shaft body is cut to form the groove portion, the weld bead is formed along the edge portion of the groove portion to close the groove portion to form the hollow portion, and the weld bead is deposited on the outer periphery of the shaft body to build the built-up portion. Accordingly, the additively-manufactured object having the hollow portion and the groove portion which is closed by the weld bead can be manufactured. In the manufacturing method, it is possible to reduce the number of building steps using the weld bead, and to greatly reduce the difficulty of forming the hollow portion, as compared with a case where a side wall portion and a ceiling portion are built using a weld bead to build a hollow portion.

Accordingly, the additively-manufactured object having the hollow portion can be manufactured easily and with high accuracy, and a lead time required for manufacturing can be greatly shortened. In the additively-manufactured object, the formed hollow portion can be used as, for example, a flow portion through which a cooling medium passes.

(2) The method for manufacturing an additively-manufactured object according to (1), wherein the method comprises a cutting step of cutting the built-up portion to form a blade after the building step.

In the method for manufacturing the additively-manufactured object, the additively-manufactured object with the blade and having the hollow portion used as a flow path can be obtained by forming the blade by cutting the built-up portion built by depositing the weld bead.

(3) The method for manufacturing an additively-manufactured object according to (1) or (2), wherein a shaft body having a large diameter portion in at least a part in an axial direction thereof is used as the shaft body.

In the method for manufacturing the additively-manufactured object, it is possible to greatly reduce the number of deposited weld beads when the built-up portion is built by the weld bead, and to improve the manufacturing efficiency. By using the shaft body having the large diameter portion, it is possible to easily manufacture a rotor having a large diameter or the like.

(4) The method for manufacturing an additively-manufactured object according to (3), wherein in the groove portion processing step, the groove portion is formed in the large diameter portion of the shaft body.

In the method for manufacturing the additively-manufactured object, the groove portion is formed in the large diameter portion, and thus the groove portion having a large depth can be easily formed. Accordingly, the additively-manufactured object having the larger hollow portion can be easily manufactured.

(5) The method for manufacturing an additively-manufactured object according to any one of (1) to (4), wherein in the groove portion processing step, the groove portion is spirally formed with respect to the shaft body.

In the method for manufacturing the additively-manufactured object, by spirally forming the groove portion, it is possible to easily manufacture the additively-manufactured object having the flow path formed by the hollow portion covering the periphery of the shaft body in the axial direction. As compared with the case where the side wall portion is built by the weld bead, the hollow portion as the flow path can be easily extended.

(6) An additively-manufactured object comprising:
a rod-shaped shaft body;
a built-up portion provided on an outer periphery of the shaft body and formed by depositing a weld bead obtained by melting and solidifying a filler metal; and
a hollow portion formed along the outer periphery of the shaft body,
wherein the hollow portion is surrounded by a groove portion formed in the outer periphery of the shaft body, and the weld bead formed along an edge portion of the groove portion to close the groove portion.

In the additively-manufactured object, the hollow portion formed along the outer periphery of the shaft body is provided. Accordingly, the hollow portion can be used as a flow path through which a cooling medium such as cooling water passes.

The hollow portion is formed by the groove portion formed in the outer periphery of the shaft body and the weld bead formed along the edge portion of the groove portion. That is, the hollow portion can be easily formed by cutting the outer periphery of the shaft body to form the groove portion, and forming the weld bead along the edge portion of the groove portion to close the groove portion.

(7) The additively-manufactured object according to (6), wherein the built-up portion has a blade formed.

In the additively-manufactured object, it is possible to provide an additively-manufactured object with a blade in which the hollow portion is used as a flow path for a cooling medium.

The present application is based on Japanese Patent Application No. 2020-138614 filed on Aug. 19, 2020, and the contents thereof are incorporated herein by reference.

### REFERENCE SIGNS LIST

51: Shaft body
51A: Large diameter portion
53: Built-up portion
55: Blade
57: Hollow portion
59: Groove portion
B: Weld bead
M: Filler metal
W: Additively-manufactured object

1. A method for manufacturing an additively-manufactured object, the additively-manufactured object comprising a rod-shaped shaft body, and a built-up portion formed by depositing weld beads obtained by melting and solidifying a filler metal on an outer periphery of the shaft body, the method comprising:
a groove portion processing step of forming a groove portion by cutting the outer periphery of the shaft body;
a groove portion closing step of forming a first weld bead of the weld beads along the groove portion on an edge portion of the groove portion in the shaft body to close the groove portion to form a hollow portion; and
a building step of building the built-up portion by depositing a second weld bead of the weld beads on the outer periphery of the shaft body.

2. The method for manufacturing an additively-manufactured object according to claim 1, wherein the method comprises a cutting step of cutting the built-up portion to form a blade after the building step.

3. The method for manufacturing an additively-manufactured object according to claim 1, wherein a shaft body having a large diameter portion in at least a part in an axial direction thereof is used as the shaft body.

4. The method for manufacturing an additively-manufactured object according to claim 2, wherein a shaft body having a large diameter portion in at least a part in an axial direction thereof is used as the shaft body.

5. The method for manufacturing an additively-manufactured object according to claim 3, wherein in the groove portion processing step, the groove portion is formed in the large diameter portion of the shaft body.

6. The method for manufacturing an additively-manufactured object according to claim 4, wherein in the groove portion processing step, the groove portion is formed in the large diameter portion of the shaft body.

7. The method for manufacturing an additively-manufactured object according to claim 1, wherein in the groove portion processing step, the groove portion is spirally formed with respect to the shaft body.

8. An additively-manufactured object comprising:
a rod-shaped shaft body;
a built-up portion provided on an outer periphery of the shaft body and formed by depositing a second weld beads obtained by melting and solidifying a filler metal; and
a hollow portion formed along the outer periphery of the shaft body,
wherein the hollow portion is surrounded by a groove portion formed in the outer periphery of the shaft body, and a first weld beads formed along an edge portion of the groove portion to close the groove portion.

9. The additively-manufactured object according to claim 8, wherein the built-up portion has a blade formed.

10. The method for manufacturing an additively-manufactured object according to claim 2, wherein in the groove portion processing step, the groove portion is spirally formed with respect to the shaft body.

11. The method for manufacturing an additively-manufactured object according to claim 3, wherein in the groove portion processing step, the groove portion is spirally formed with respect to the shaft body.

12. The method for manufacturing an additively-manufactured object according to claim 4, wherein in the groove portion processing step, the groove portion is spirally formed with respect to the shaft body.

13. The method for manufacturing an additively-manufactured object according to claim 5, wherein in the groove portion processing step, the groove portion is spirally formed with respect to the shaft body.

14. The method for manufacturing an additively-manufactured object according to claim 6, wherein in the groove portion processing step, the groove portion is spirally formed with respect to the shaft body.
